(19) United States
(12) Patent Application Publication
(10) Pub. No.: US 2015/0382051 A1
(43) Pub. Date: Dec. 31, 2015

(54) TIME SYNCHRONIZING METHOD, TIME CONNECTING SYSTEM, TIME MASTER INSTRUMENT, AND TIME SLAVE INSTRUMENT

(71) Applicant: Azbil Corporation, Tokyo (JP)

(72) Inventor: Kengo KUROYANAGI, Tokyo (JP)

(73) Assignee: AZBIL CORPORATION, Tokyo (JP)

(21) Appl. No.: 14/749,819

(22) Filed: Jun. 25, 2015

(30) Foreign Application Priority Data
Jun. 25, 2014 (JP) 2014-130442

(51) Int. Cl. H04N 21/43

(52) U.S. Cl. CPC H04N 21/4302

(57) ABSTRACT

A time master instrument includes: a time information transmitting portion that transmits local time information to time slave instruments; a time information response requesting portion that requests that, through unicasting to the time slave instruments, time information be sent back; a time information comparing portion that compares the time information from the time slave instrument and the local time information; and a notifying portion that notifies a user when the time information comparing portion evaluates that there is a discrepancy in time information. A slave instrument includes: a time information setting portion that sets time information transmitted by the time information transmitting portion; a time information acquiring portion that acquires local time information in response to a response request by the time information response requesting portion; and a time information responding portion that sends back, to the time master instrument, time information acquired by the time information acquiring portion.

### CROSS REFERENCE TO RELATED APPLICATION

This application claims priority under 35 U.S.C. §119 to Japanese Patent Application No. 2014-130442, filed on Jun. 25, 2014, the entire content of which being hereby incorporated herein by reference.

### FIELD OF TECHNOLOGY

The present invention relates to a time synchronizing method by a time synchronizing system that includes a time master instrument and a plurality of time slave instruments that are connected to the time master instrument, and relates to a time synchronizing system, a time master instrument, and a time slave instrument.

### BACKGROUND

Building monitoring systems are structured through combining a plurality of nodes. Given this, normally the node at the user interface is a time master instrument, and the other nodes are time slave instruments, wherein the time master instrument carries out time synchronization through sending time information to the time slave instruments. In this time synchronization, broadcasting is carried out in order to avoid complexity in system design and engineering. See, for example, Japanese Unexamined Patent Application Publication No. 2013-108895.

However, in the time master instrument there is an issue in that, after the time information has been transmitted, it is not possible to know whether or not the time synchronization has been achieved at the time slave instruments. Because of this, if, due to an incorrect setting or each communication problem, there is a problem wherein there is a loss of time synchronization due to the inability for a time slave instrument to synchronize to the time master instrument, the time master instrument is unable to detect this state, and has no method by which to provide notification to the user. Moreover, if the user leave things as they are, unaware that there is a time discrepancy, this may lead to problems such as lost data or delayed control in the building (for example, a delay in the time with which the building is unlocked), and the like.

For example, in BACnet, which is a protocol in building monitoring, a time synchronizing message (TimeSynchronization) is transmitted. However, in this case it is not possible for the time master instrument, after transmitting the time information, to ascertain whether or not time synchronization has been achieved in the time slave instrument.

Moreover, as a typical method for time synchronization there is a method wherein each individual node uses an NTP (Network Time Protocol) to acquire the time from an NTP server. However, even when this protocol is used, the time master instrument is unable to discover whether or not the time synchronization has been achieved in the individual nodes.

The present invention was created in order to solve issues such as those set forth above, and an aspect thereof is to provide a time synchronizing method, a time synchronizing system, a time master instrument, and a time slave instrument wherein it is possible for the time master instrument to confirm the state of time synchronization of the time slave instruments.

### SUMMARY

A time synchronizing method according to the present invention uses a time synchronizing system including a time master instrument and a plurality of time slave instruments that are connected to the time master instrument. The time master instrument performs: a time information transmitting step for transmitting local time information to the time slave instruments through broadcasting through a time information transmitting portion; a time information response requesting step for requesting that, through unicasting to the time slave instruments through a time information response requesting portion, time information be sent back; a time information comparing step for comparing the time information sent back from the time slave instrument and the local time information, through a time information comparing portion; and a notifying step for notifying a user, through a notifying portion, when there is an evaluation by the time information comparing portion that there is a discrepancy in time information. The slave instrument preforms: a time information setting step for setting, through the time information setting portion, as local time information, time information that has been transmitted by the time information transmitting portion; a time information acquiring step for acquiring, through a time information acquiring portion, local time information in response to a response request for time information, transmitted by the time information response requesting portion; and a time information responding step for sending back, by the time information responding portion, to the time master instrument, time information acquired by the time information acquiring portion.

Moreover, a time synchronizing system according to the present invention includes a time master instrument and a plurality of time slave instruments that are connected to the time master instrument. The time master instrument includes: a time information transmitting portion that transmits local time information to the time slave instruments through broadcasting; a time information response requesting portion that requests that, through unicasting to the time slave instruments, time information be sent back; a time information comparing portion that compares the time information sent back from the time slave instrument and the local time information; and a notifying portion that notifies a user when there is an evaluation by the time information comparing portion that there is a discrepancy in time information. The slave instrument includes: a time information setting portion that sets time information that has been transmitted by the time information transmitting portion; a time information acquiring portion that acquires local time information in response to a response request for time information, transmitted by the time information response requesting portion; and a time information responding portion that sends back to the time master instrument, time information acquired by the time information acquiring portion.

Because this invention uses the structure set forth above, it becomes possible for the time master instrument to confirm the state of time synchronization of the time slave instruments.

### BRIEF DESCRIPTIONS OF THE DRAWINGS

FIG. 1 is a diagram illustrating a structure for a time synchronizing system according to an example according to the present invention.

FIG. 2 is a flowchart illustrating the operation of a time master instrument according to the example according to the present invention.

FIG. 3 is a flowchart illustrating the operation of a time slave instrument according to the example according to the present invention.

FIG. 4 is a diagram for explaining a summary of the operations of the time synchronizing system in the example according to the present invention.

### DETAILED DESCRIPTION

Examples according to the present disclosure will be explained in detail below referencing the figures.

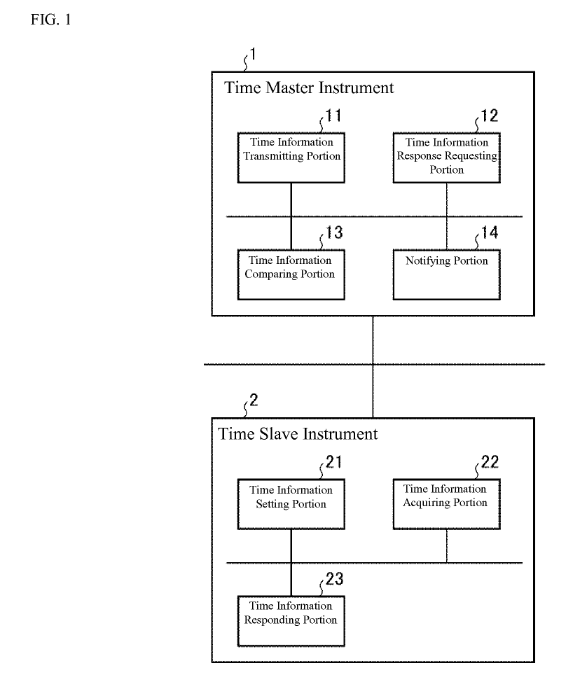

FIG. 1 is a diagram illustrating a structure for a time synchronizing system according to an example according to the present invention.

As illustrated in FIG. 1, the time synchronizing system is structured from a time master instrument 1 and a plurality of time slave instruments 2 that are connected to the time master instrument 1. Note that only a single time slave instrument 2 is illustrated in FIG. 1. Moreover, normally, of the nodes that structure a system, the node at the user interface is the time master instrument 1, and the other nodes are time slave instruments 2. Moreover, in a time synchronizing system, program procedures are executed using a CPU based on software.

As illustrated in FIG. 1, the time master instrument 1 has a time information transmitting portion 11, a time information response requesting portion 12, a time information comparing portion 13, and a notifying portion 14.

The time information transmitting portion 11 is that which transmits local time information, through broadcasting, to the time slave instruments 2. Note that the time information of the time master instrument 1 is set through acquiring reference time information through a GPS, or the like.

The time information response requesting portion 12 is that which transmits a response request for time information, through unicasting, to the time slave instruments 2. The response requests for time information, to the time slave instruments 2, are carried out on a regular periodic basis.

At the time information comparing portion 13 is that which compares the time information that is sent back from the time information responding portion 23 of the time slave instrument 2 to the local time information.

The notifying portion 14 is that which notifies the user when there is an evaluation by the time information comparing portion 13 that there is a discrepancy in the time information. Note that as a method for providing notification to the user by the notifying portion 14, a screen indicating that there is a discrepancy in time information, for example, may be displayed on a monitor (not shown), a buzzer may be sounded, or printing may be performed.

As illustrated in FIG. 1, the time slave instrument 2 has a time information setting portion 21, a time information acquiring portion 22, and a time information responding portion 23.

The time information setting portion 21 is that which sets, as local time information, time information that is transmitted from the time information transmitting portion 11 of the time master instrument 1.

The time information acquiring portion 22 is that which acquires local time information, in response to a response request for time information that has been sent by the time information response requesting portion 12 of the time master instrument 1.

The time information responding portion 23 is that which sends back, to the time master instrument 1, time information acquired from the time information acquiring portion 22.

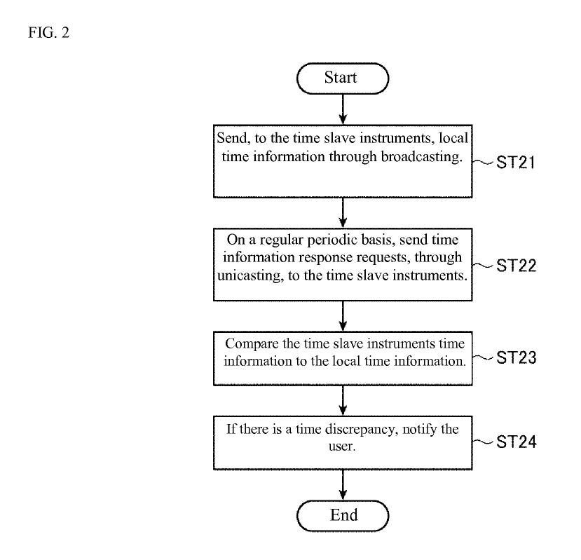

The operation by the time synchronizing system, structured as described above, will be explained next in reference to FIG. 2 through 4. The operation of the time master instrument 1 will be explained first, in reference to FIG. 2.

In the operation of the time master instrument 1, as illustrated in FIG. 2, first the time information transmitting portion 11 transmits local time information, through broadcasting, to the time slave instruments 2 (Step ST21, a time information transmitting step).

Following this, the time information response requesting portion 12 sends, on a regular periodic basis, time information response requests to the time slave instruments 2 through unicasting (Step ST22, a time information response requesting step). Given this, time information is sent back from the time slave instrument 2 in response to this response request.

Following this, the time information comparing portion 13 compares the time information sent back from the time information responding portion 23 of the time slave instrument 2 to the local time information (Step ST23, a time information comparing step).

Following this, if the evaluation by the time information comparing portion 13 is that there is a time information discrepancy, the notifying portion 14 provides notification to this effect to the user (Step ST24, a notifying step).

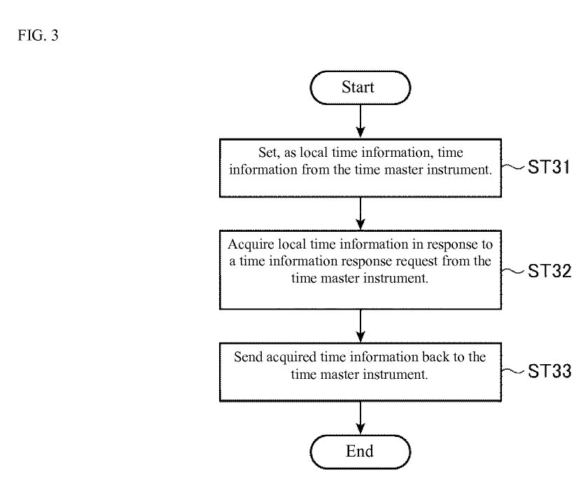

The operation in the time slave instrument 2 will be explained next in reference to FIG. 3.

In the operation of the time slave instrument 2, as illustrated in FIG. 3, the time information setting portion 21 sets, as local time information, the time information that has been transmitted from the time information transmitting portion 11 of the time master instrument 1 (Step ST31, a time information setting step).

On the other hand, when a response request for time information from the time information response requesting portion 12 of the time master instrument 1 has been transmitted, the time information acquiring portion 22 acquires the local time information in response to that response request (Step ST32, a time information acquiring step).

Following this, the time information responding portion 23 sends, to the time master instrument 1, the time information acquired by the time information acquiring portion 22 (Step ST33, a time information responding step).

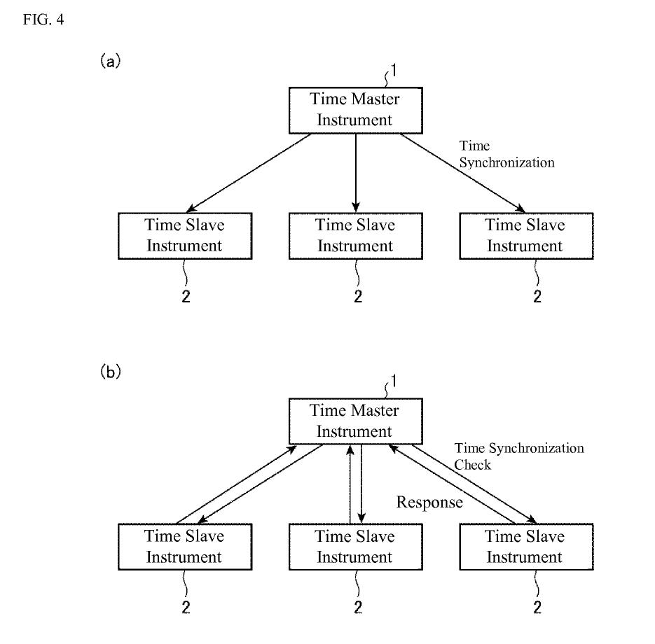

That is, as illustrated in FIG. 4, two operations, that is, a time synchronizing operation and a time synchronization checking operation, are carried out in the operation of the time synchronizing system according to the present invention. Here, in the time synchronizing operation, illustrated in FIG. 4 (a), the time synchronization is carried out through broadcasting from the time master instrument 1 to the time slave instruments 2, in the same manner as is performed conventionally. Following this, in the time synchronization checking operation, illustrated in FIG. 4 (b), the time master instrument 1 queries the time information of the time slave instruments 2, through unicasting, on a regular periodic basis, compares the time information obtained from the time slave instruments 2 to the local time information, and provides notification to the user if there is a time discrepancy.

As described above, given the example, the time master instrument 1 is structured so as to acquire, on a regular periodic basis, the time information of the time slave instruments 2, and compares the local time information to evaluate whether or not there is a time discrepancy, thus making it possible, in the time master instrument 1, to check the state of time synchronization of the time slave instruments 2. Consequently, it becomes possible, in the system as a whole, to guarantee the time more reliably, making it possible to perform confirmations, and to carry out countermeasures, quickly if a time slave instrument 2 is unable to achieve time synchronization.

Note that in the invention in the present application, arbitrary structural elements in the example may be modified, or arbitrary structural elements in the example may be omitted, within the scope of the invention.

1: A time synchronizing method using a time synchronizing system comprising a time master instrument and a plurality of time slave instruments that are connected to the time master instrument, the method comprising:
a time information transmitting step, performed by the time master instrument, for transmitting local time information to the time slave instruments through broadcasting through a time information transmitting portion;
a time information response requesting step, performed by the time master instrument, for requesting that, through unicasting to the time slave instruments through a time information response requesting portion, time information be sent back;
a time information comparing step, performed by the time master instrument, for comparing the time information sent back from the time slave instrument and the local time information, through a time information comparing portion;
a notifying step, performed by the time master instrument, for notifying a user, through a notifying portion, when there is an evaluation by the time information comparing portion that there is a discrepancy in time information;
a time information setting step, performed by the slave instrument, for setting, through the time information setting portion, as local time information, time information that has been transmitted by the time information transmitting portion;
a time information acquiring step, performed by the slave instrument, for acquiring, through a time information acquiring portion, local time information in response to a response request for time information, transmitted by the time information response requesting portion; and
a time information responding step, performed by the slave instrument, for sending back, by the time information responding portion, to the time master instrument, time information acquired by the time information acquiring portion.

2: A time synchronizing system comprising:
a time master instrument; and
a plurality of time slave instruments that are connected to the time master instrument, wherein:
the time master instrument includes:
a time information transmitting portion that transmits local time information to the time slave instruments through broadcasting;
a time information response requesting portion that requests that, through unicasting to the time slave instruments, time information be sent back;
a time information comparing portion that compares the time information sent back from the time slave instrument and the local time information; and
a notifying portion that notifies a user when there is an evaluation by the time information comparing portion that there is a discrepancy in time information; and
the slave instrument includes:
a time information setting portion that sets time information that has been transmitted by the time information transmitting portion;
a time information acquiring portion that acquires local time information in response to a response request for time information, transmitted by the time information response requesting portion; and
a time information responding portion that sends back to the time master instrument, time information acquired by the time information acquiring portion.

3: A time master instrument to which a plurality of time slave instruments are attached, comprising:
a time information transmitting portion that transmits local time information to the time slave instruments through broadcasting;
a time information response requesting portion that requests that, through unicasting to the time slave instruments, time information be sent back;
a time information comparing portion that sets, as local time information, time information that is sent from the time information transmitting portion, acquires local time information in response to a time information response request, transmitted from the time information response requesting portion, and compares, to the local time information, the time information that is sent back; and
a notifying portion that notifies a user when there is an evaluation by the time information comparing portion that there is a discrepancy in time information.

4: A plurality of time slave instruments attached to a time master instrument, comprising:
a time information setting portion that sets, as local time information, time information of the time master instrument that has been transmitted through broadcasting by the time master instrument;
a time information acquiring portion that acquires local time information in response to a response request for time information, transmitted through unicasting by the time master instrument; and
a time information responding portion that sends back to the time master instrument, time information acquired by the time information acquiring portion.
